(19) United States
(12) Patent Application Publication
(10) Pub. No.: US 2023/0147510 A1
(43) Pub. Date: May 11, 2023

(54) LIQUID FABRIC SOFTENER COMPOSITIONS COMPRISING HYDROXYPROPYL STARCH PHOSPHATE

(71) Applicant: NOURYON CHEMICALS INTERNATIONAL B.V., Amsterdam (NL)

(72) Inventors: Maryalice Belluscio, Long Valley, NJ (US); Dayane Reis Silva Jacomassi, Valinhos-SP (BR); Patricia Amorim De Almeida Campos, Jundiai-SP (BR); Ana Claudia Biancardi, Jundiai-SP (BR)

(73) Assignee: NOURYON CHEMICALS INTERNATIONAL B.V., Amsterdam (NL)

(21) Appl. No.: 18/052,293

(22) Filed: Nov. 3, 2022

Related U.S. Application Data
(60) Provisional application No. 63/276,190, filed on Nov. 5, 2021.

(51) Int. Cl. C11D 3/00; C11D 3/22; C11D 1/62

(52) U.S. Cl. CPC C11D 3/0015; C11D 3/228; C11D 1/62

(57) ABSTRACT

A liquid fabric softener composition in accordance with an exemplary embodiment comprises a fabric softener active agent, a hydroxypropyl starch phosphate, and water.

### CROSS-REFERENCE TO RELATED APLICATION

This application claims the benefit of U.S. Provisional Application No. 63/276,190, filed Nov. 5, 2021, the entire content of which is incorporated by reference herein.

### TECHNICAL FIELD

The technical field relates to liquid fabric softener compositions.

### BACKGROUND

As is well-known in the art, fabric softeners are highly cationic and it has proven difficult to find compatible rheology modifiers and stabilizers. The problem is exacerbated with newer, more concentrated formulas. Further, most commercial fabric softeners in use today are stabilized by non-biodegradable synthetic polymers. Thus, there is a need in the art for new chemistries that are compatible with both dilute and concentrated fabric softener compositions in use yet which are readily biodegradable.

U.S. Pat. No. 9,109,068 describes biodegradable hybrid copolymers composed of at least one ethylenically unsaturated monomer and a naturally derived hydroxyl-containing transfer agent. These materials are envisioned to have a large number of uses, including as rheology modifiers in fabric softeners. According to this patent, hydroxypropyl starch phosphates may be included along with many other diverse chemistries in the compositions as optional thickeners or gelling agents in cosmetic and personal care compositions. STRUCTURE® ZEA (hydroxypropyl starch phosphate) from Nouryon is included in a combing cream for dry/damaged hair, but not in any exemplified fabric softener formulation. Accordingly, there is a need for an improved liquid fabric softener composition characterized by improved rheology modification, formula stability, ready biodegradability, high natural content, improved bloom, and renewability.

### BRIEF SUMMARY

In accordance with an exemplary embodiment, a liquid fabric softener composition comprises:

(a) a fabric softener active agent;
(b) a hydroxypropyl starch phosphate; and
(c) water.

In accordance with another exemplary embodiment, a liquid fabric softener composition comprises:

(a) a fabric softener active agent;
(b) a crosslinked hydroxypropyl starch phosphate, wherein the crosslinked hydroxypropyl starch phosphate is derived from a waxy maize starch that has been subjected to non-ionic modification with propylene oxide, crosslinked with phosphorus oxychloride, then physically modified by jet cooking, spray drying, and agglomeration; and
(c) water.

In accordance with a further exemplary embodiment, a liquid fabric softener composition comprises:

(a) a fabric softener active agent, which is a mono-ester, di-ester, or tri-ester quaternary ammonium compound;
(b) a crosslinked hydroxypropyl starch phosphate, wherein the crosslinked hydroxypropyl starch phosphate is derived from a waxy maize starch that has been subjected to non-ionic modification with propylene oxide, crosslinked with phosphorus oxychloride, then physically modified by jet cooking, spray drying, and agglomeration; and
(c) water.

### DETAILED DESCRIPTION

The following detailed description is merely exemplary in nature and is not intended to limit the disclosure. Furthermore, there is no intention to be bound by any theory presented in the preceding background or the following detailed description.

In accordance with an exemplary embodiment, a liquid fabric softener composition comprises a fabric softener active agent, a hydroxypropyl starch phosphate, and water. In a preferred embodiment, the fabric softener active agent is a cationic fabric softener active agent. In a more preferred embodiment, the cationic fabric softener active agent is a quaternary ammonium compound.

In an especially preferred embodiment, the quaternary ammonium compound is a “quat” of the formula N+R1R2R3R4 X−, wherein one, two, three, or all four of R1, R2, R3 and R4 independently represent hydrocarbyl groups having 6-24 carbon atoms; and the remainder of R1, R2, R3, and R4 that do not represent said hydrocarbyl groups having 6-24 carbon atoms, if any, independently represent hydrocarbyl groups having 1-4 carbon atoms; and X− is an anion, preferably selected from halide, methyl sulfate, and ethyl sulfate radicals.

In a more preferred embodiment, R1 and R2 independently represent linear and saturated or mono-unsaturated hydrocarbyl groups having 8-22 carbon atoms, more preferably 12-20 carbon atoms, and most preferably 14-18 carbon atoms; and R3 and R4 independently represent alkyl groups having 1-6 carbon atoms, more preferably 1-3 carbon atoms, most preferably methyl groups.

In a most preferred embodiment, these quats are selected from ditallow dimethyl ammonium chloride, ditallow dimethyl ammonium methyl sulfate, dihexadecyl dimethyl ammonium chloride, di(hydrogenated tallow) dimethyl ammonium chloride, di(hydrogenated tallow) dimethyl ammonium methyl sulfate, dihexadecyl diethyl ammonium chloride, tritallow methyl ammonium chloride, di(coconut) dimethyl ammonium chloride, and di(coconut) dimethyl ammonium methosulfate, and mixtures thereof.

The foregoing quats are well-known in the art, for example, from EP 0 332 270 and US 2016/0215237, the entire contents of which are hereby incorporated herein by reference.

In another especially preferred embodiment, the quaternary ammonium compound is an “ester quat” of the formula N+R1R2R3R4 X−, wherein one, two, or all three of R1, R2, and R3 independently represent hydrocarbyl groups having 6-24 carbon atoms interrupted by an ester linkage; and the remainder of R1, R2, R3 along with R4 independently represent hydrocarbyl groups having 1-8 carbon atoms or hydroxyhydrocarbyl groups having 1-8 carbon atoms; and X− is an anion, preferably selected from halide, methyl sulfate, and ethyl sulfate radicals.

In a more preferred embodiment, the ester quat is a monoester quat.

In another more preferred embodiment, the ester quat is a diester quat.

In yet another more preferred embodiment, the ester quat is a triester quat.

In each of the foregoing ester quat embodiments, in a more preferred embodiment of same, R1 and R2 independently represent linear and saturated or mono-unsaturated hydrocarbyl groups having 8-22 carbon atoms, more preferably 12-20 carbon atoms, and most preferably 14-18 carbon atoms; and R3 and R4 independently represent alkyl or hydroxyalkyl groups having 1-6 carbon atoms, more preferably 1-3 carbon atoms, most preferably 1 or 2 carbon atoms.

In a most preferred embodiment, these ester quats are selected from ditallowoyloxyethyl dimethyl ammonium chloride, dihydrogenated-tallowoyloxyethyl dimethyl ammonium chloride, dicanola-oyloxyethyl dimethyl ammonium chloride, ditallowoyloxyethyl dimethyl ammonium methyl sulfate, 1,2-bis(hardened tallowoyloxy) trimethylammonium propane chloride, dihardened tallow dimethyl ammonium chloride, di-(hydrogenated tallowoyloxyethyl)-N,N-methylhydroxyethylammonium methylsulfate, dehydrogenated palmoylethyl hydroxyethylmonium methosulfate, dipalmoxyethyl dimethylammonium chloride, and di-(oleoyloxyethyl)-N,N-methylhydroxyethylammonium methylsulfate, and mixtures thereof.

In another especially preferred embodiment, the quaternary ammonium compound is an “amide quat” of the formula N+R1R2R3R4 X−, wherein one, two, or all three of R1, R2, and R3 independently represent hydrocarbyl groups having 6-24 carbon atoms interrupted by an amide linkage; and the remainder of R1, R2, R3 along with R4 independently represent hydrocarbyl groups having 1-8 carbon atoms or hydroxyhydrocarbyl groups having 1-8 carbon atoms; and X− is an anion, preferably selected from halide, methyl sulfate, and ethyl sulfate radicals.

In each of the foregoing amide quat embodiments, in a more preferred embodiment of same, R1 and R2 independently represent linear and saturated or mono-unsaturated hydrocarbyl groups having 8-22 carbon atoms, more preferably 12-20 carbon atoms, and most preferably 14-18 carbon atoms; and R3 and R4 independently represent alkyl or hydroxyalkyl groups having 1-6 carbon atoms, more preferably 1-3 carbon atoms, most preferably 1 or 2 carbon atoms.

In a more preferred embodiment, these amide quats are selected from methyl bis(tallow amidoethyl)-2-hydroxyethyl ammonium methyl sulfate, methyl bis(hydrogenated tallow amidoethyl)-2-hydroxyethyl ammonium methyl sulfate, and methyl bis(oleyl amidoethyl)-2-hydroxyethyl ammonium methyl sulfate, and mixtures thereof.

The foregoing ester quats and amide quats are well-known in the art, for example, from U.S. Pat. Nos. 9,109,068 and 6,037,315, the entire contents of which are hereby incorporated herein by reference.

These and other useful fabric softener active agents can be made by reacting fatty acids with alkanolamines, such as MDEA (methyldiethanolamine) and TEA (triethanolamine), or with aminoalkylamines, such as methyldiaminoethylamine or triaminoethylamine Some materials that typically result from such reactions include N,N-di(acyl-oxyethyl)-N,N-dimethylammonium chloride or N,N-di(acyloxyethyl)-N,N-methylhydroxyethylammonium methylsulfate wherein the acyl group is derived from animal fats, unsaturated, and polyunsaturated, fatty acids, e.g., oleic acid, and/or partially hydrogenated fatty acids, derived from vegetable oils and/or partially hydrogenated vegetable oils, such as, palm oil, hydrogenated palm oil, canola oil, safflower oil, peanut oil, sunflower oil, corn oil, soybean oil, tall oil, rice bran oil, and the like. Those skilled in the art will recognize that active softener materials made from such process can comprise a combination of mono-, di-, and tri-esters or the corresponding mono-, di-, and tri-amides depending on the process and the starting materials. One embodiment contemplates an ester mixture rich in di-esters, for example, containing more than 50%, or more than 60% di-esters, with the remainder being predominately mono-esters. Another embodiment contemplates an ester mixture containing at three ester types, i.e., mono-, di-, and tri-esters.

In a preferred embodiment, the hydroxypropyl starch phosphate is cold water processable.

In an especially preferred embodiment, the hydroxypropyl starch phosphate is crosslinked.

In a more preferred embodiment, the crosslinked hydroxypropyl starch phosphate is jet cooked. In an even more preferred embodiment, the crosslinked hydroxypropyl starch phosphate is jet cooked and dried. Drying can be accomplished by any suitable means, such as spray drying, drying in a fluidized bed, drum drying, and the like.

In a most preferred embodiment, the crosslinked hydroxypropyl starch phosphate is jet cooked and spray dried.

In another more preferred embodiment, the crosslinked hydroxypropyl starch phosphate is jet cooked, spray dried, and agglomerated. The resulting product is characterized by cold water processability and easy handling due to low dusting and ease of dissolution. Processes for jet cooking, spray drying, and agglomerating starch are well-known in the art. See, for example, U.S. Pat. No. 6,248,338, the entire contents of which are incorporated herein by reference.

Suitable sources of the starch include natural starch sources, such as wheat, maize, pea, potato, barley, tapioca, rice, sago, sorghum, and mixtures thereof. Preferably, the source is rice, barley, maize, tapioca, and mixtures thereof. More preferably, the source is waxy maize starch.

In a more preferred embodiment, the crosslinked hydroxypropyl starch phosphate is a waxy maize starch that has been jet cooked, spray dried, agglomerated.

In an especially preferred embodiment, the crosslinked hydroxypropyl starch phosphate is derived from a waxy maize starch that has been subjected to non-ionic modification to create the hydroxypropyl functionality on the starch, crosslinked with phosphorus oxychloride, then physically modified by jet cooking, spray drying, and agglomeration. Processing in this manner has the advantage of rendering the product cold water processable and easy to handle due to low dusting and ease of dissolution. Materials of this type are available from Nouryon under the tradenames STRUCTURE® XL (hydroxypropyl starch phosphate), STRUCTURE® ZEA (hydroxypropyl starch phosphate), and STRUCTURE® 2143 (hydroxypropyl starch phosphate).

In an alternative embodiment, the hydroxypropyl starch phosphate is processed with heating, but care must be taken that the heat utilized does not degrade the starch. A material of this type is also available from Nouryon under the tradename STRUCTURE® HVS (hydroxypropyl starch phosphate).

In addition to the ingredients (a), (b), and (c) mentioned above, suitable fabric softener compositions will typically contain one or more of electrolytes, phase stabilizing polymers, perfumes, nonionic surfactants, non-aqueous solvents, silicones, fatty acids, fatty alcohols, dyes, colorants, preservatives, optical brighteners, antifoam agents, chelates, and mixtures thereof. Useful solvents include isopropanol, ethanol, benzyl alcohol, glycerin, propylene glycol, and mixtures thereof. Weak acids may be used to adjust the formulation pH. Salts, such as calcium chloride, may also be added to reduce and control viscosity.

In another especially preferred embodiment, a liquid fabric softener composition comprises:

(a) a fabric softener active agent;
(b) a crosslinked hydroxypropyl starch phosphate;
(c) water; and
(d) one or more further ingredients selected from the group consisting of surfactants, electrolytes, phase stabilizing polymers, perfumes, nonionic surfactants, non-aqueous solvents, silicones, fatty acids, dyes, colorants, preservatives, optical brighteners, and antifoam agents.

In a more preferred embodiment, a liquid fabric softener composition comprises:

(a) a fabric softener active agent, which is a mono-ester, di-ester, or tri-ester quaternary ammonium compound;
(b) a crosslinked hydroxypropyl starch phosphate, wherein the crosslinked hydroxypropyl starch phosphate is derived from a waxy maize starch that has been subjected to non-ionic modification with propylene oxide, crosslinked with phosphorus oxychloride, then physically modified by jet cooking, spray drying, and agglomeration;
(c) water; and
(d) one or more further ingredients selected from the group consisting of surfactants, electrolytes, phase stabilizing polymers, perfumes, nonionic surfactants, non-aqueous solvents, silicones, fatty acids, dyes, colorants, preservatives, optical brighteners, and antifoam agents.

In another especially preferred embodiment, the liquid fabric softener composition is substantially free of hybrid copolymers. By “hybrid copolymer” as used herein is meant a hybrid copolymer as described in U.S. Pat. No. 9,109,068, comprising at least one ethylenically unsaturated monomer and a naturally derived hydroxyl-containing transfer agent. By “substantially free of hybrid copolymers” as used herein is meant the fabric softener compositions contemplated herein contain such hybrid copolymers in less than about 0.1 to about 3.0% by weight, based on a total weight of the composition, or less than about 0.1% by weight, based on a total weight of the composition. In a most preferred embodiment, the fabric softener composition as contemplated herein is completely free of such hybrid copolymers.

In a most preferred embodiment, therefore a liquid fabric softener composition comprises:

(a) a fabric softener active agent, which is a mono-ester, di-ester, or tri-ester quaternary ammonium compound;
(b) a crosslinked hydroxypropyl starch phosphate, wherein the crosslinked hydroxypropyl starch phosphate is derived from a waxy maize starch that has been subjected to non-ionic modification with propylene oxide, crosslinked with phosphorus oxychloride, then physically modified by jet cooking, spray drying, and agglomeration;
(c) water; and
(d) one or more further ingredients selected from the group consisting of surfactants, electrolytes, phase stabilizing polymers, perfumes, nonionic surfactants, non-aqueous solvents, silicones, fatty acids, dyes, colorants, preservatives, optical brighteners, and antifoam agents;
wherein the fabric softener composition is completely free of hybrid copolymer.

The fabric softener compositions can be provided in dilute or concentrated form. Solid particulate forms are also possible, although preference is given to liquid forms.

For dilute forms, the content of the fabric softener active ingredient ranges from about 1 to about 15% by weight, preferably from about 3 to about 12% by weight, most preferably about 5 to about 10% by weight. The content of the hydroxypropyl starch phosphate ranges from about 0.01 to about 10% by weight, preferably about 0.1 to about 5% by weight, most preferably about 1 to about 3% by weight. The total content of the further ingredients ranges from about 0.01 to about 10% by weight, preferably from about 0.1 to about 8% by weight, most preferably from about 0.1 to about 5% by weight. The balance of the fabric softener composition is water. In an embodiment, the water content ranges from about 65 to about 98% by weight, preferably about 75 to about 95% by weight, most preferably about 85 to about 92% by weight. The percentage by weight in each of the foregoing cases is based on a total weight of the dilute fabric softener composition.

For concentrated forms, the content of the fabric softener active ingredient is higher, ranging from about 1 to about 35% by weight, preferably from about 6 to about 24% by weight, most preferably about 10 to about 20% by weight. The content of the hydroxypropyl starch ranges from about 0.01 to about 20% by weight, preferably about 0.1 to about 10% by weight, most preferably about 2 to about 6% by weight. The total content of the further ingredients ranges from about 0.01 to about 20% by weight, preferably from about 0.1 to about 16% by weight, most preferably from about 0.1 to about 10% by weight. The balance of the fabric softener composition is water. In an embodiment, the water content ranges from about 20 to about 80% by weight, preferably about 35 to about 75% by weight, most preferably about 40 to about 70% by weight. The percentage by weight in each of the foregoing cases is based on a total weight of the concentrated fabric softener composition.

Preferably, the compositions contemplated herein are dispersions having a milky appearance and formulated to a pH of about 2.0 to about 4.5, most preferably about 3.5 to about 4.0. In addition to imparting a soft feel to fabrics, the compositions contemplated herein also impart anti-static characteristics. Preferably, they are stable to precipitation, color, and odor, and the presence of the hydroxypropyl starch phosphate does not adversely affect properties of the formulations influencing softening performance, or the softening performance of the formulations themself, most preferably when the formulations are compared, for example, to a comparison formulation otherwise identical to the formulations contemplated herein except the comparison formulation lacks the hydroxypropyl starch phosphate.

The various embodiments are described with reference to the following non-limiting examples.

### EXAMPLES

### Example 1

A dilute fabric softener composition is prepared by combining the following ingredients:

| | Weight Percentage |
|---|---|
| Ingredient | (%) |
| Distearyldimethylammonium chloride | 1-2 |
| (75% active) | |
| STRUCTURE ® ZEA (hydroxypropyl | 0.1-1.0 |
| starch phosphate) | |
| Perfume | 0.2-0.5 |
| Colorant | 0.0001 |
| Water | Balance |

### Example 2

A dilute fabric softener composition is prepared by combining the following ingredients:

| | Weight Percentage |
|---|---|
| Ingredient | (%) |
| Ditallowoyloxyethyl dimethyl | 6-9 |
| ammonium chloride | |
| (75% active) | |
| STRUCTURE ® XL (hydroxypropyl | 0.1-3.0 |
| starch phosphate) | |
| Perfume | 0.2-0.5 |
| Colorant | 0.0001 |
| Water | Balance |

### Example 3

A dilute fabric softener composition is prepared by combining the following ingredients:

| | Weight Percentage |
|---|---|
| Ingredient | (%) |
| Quaternary dialkylimidazolines | 6-9 |
| (75% active) | |
| STRUCTURE ® ZEA (hydroxypropyl | 0.1-3.0 |
| starch phosphate) | |
| Perfume | 0.2-0.5 |
| Colorant | 0.0001 |
| Preservative | 0.01 |
| Water | Balance |

### Example 4

A dilute fabric softener composition is prepared by combining the following ingredients:

| | Weight Percentage |
|---|---|
| Ingredient | (%) |
| Di-(hydrogenated tallowoyloxyethyl)- | 6-9 |
| N,N-methylhydroxyethylammonium | |
| methylsulfate | |
| (75% active) | |
| STRUCTURE ® XL (hydroxypropyl | 0.1-3.0 |
| starch phosphate) | |
| Perfume | 0.2-0.5 |
| Colorant | 0.0001 |
| Preservative | 0.01 |
| Water | Balance |

### Example 5

A concentrated fabric softener composition is prepared by combining the following ingredients:

| | Weight Percentage |
|---|---|
| Ingredient | (%) |
| Distearyldimethylammonium chloride | 5 |
| (75% active) | |
| STRUCTURE ® ZEA (hydroxypropyl | 3-10 |
| starch phosphate) | |
| Lanolin | 2 |
| Ethoxylated fatty acid | 4 |
| CaCl2 | 0.05 |
| Water, perfume, color | Balance |

### Example 6

A concentrated fabric softener composition is prepared by combining the following ingredients:

| | Weight Percentage |
|---|---|
| Ingredient | (%) |
| Dipalmoxyethyl dimethyl ammonium | 14 |
| chloride | |
| (75% active) | |
| STRUCTURE ® XL (hydroxypropyl | 3-10 |
| starch phosphate) | |
| Lanolin | 2 |
| Ethoxylated fatty acid | 4 |
| CaCl2 | 0.05 |
| Water, perfume, color | Balance |

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

We claim:

1. A liquid fabric softener composition comprising:
(a) a fabric softener active agent;
(b) a hydroxypropyl starch phosphate; and
(c) water.

2. The liquid fabric softener composition according to claim 1, wherein the fabric softening active agent has the formula N+R1R2R3R4 X−, wherein one, two, three, or all four of R1, R2, R3 and R4 independently represent hydrocarbyl groups having 12-24 carbon atoms; and the remainder of R1, R2, R3, and R4 that do not represent said hydrocarbyl groups having 12-24 carbon atoms, if any, independently represent hydrocarbyl groups having 1-4 carbon atoms; and X- is an anion.

3. The liquid fabric softener composition according to claim 2, wherein the fabric softening active agent is selected from the group consisting of ditallow dimethyl ammonium chloride, ditallow dimethyl ammonium methyl sulfate, dihexadecyl dimethyl ammonium chloride, di(hydrogenated tallow) dimethyl ammonium chloride, di(hydrogenated tallow) dimethyl ammonium methyl sulfate, dihexadecyl diethyl ammonium chloride, tritallow methyl ammonium chloride, di(coconut) dimethyl ammonium chloride, and di(coconut) dimethyl ammonium methosulfate, and mixtures thereof.

4. The liquid fabric softener composition according to claim 1, wherein the fabric softening active agent has the formula N+R1R2R3R4 X−, wherein one, two, or all three of R1, R2, and R3 independently represent hydrocarbyl groups having 12-24 carbon atoms interrupted by an ester linkage; and the remainder of R1, R2, R3 along with R4 independently represent hydrocarbyl groups having 1-4 carbon atoms or hydroxyhydrocarbyl groups having 1-4 carbon atoms; and X− is an anion.

5. The liquid fabric softener composition according to claim 4, wherein the fabric softening active agent is selected from the group consisting of ditallowoyloxyethyl dimethyl ammonium chloride, dihydrogenated-tallowoyloxyethyl dimethyl ammonium chloride, dicanola-oyloxyethyl dimethyl ammonium chloride, ditallowoyloxyethyl dimethyl ammonium methyl sulfate, 1,2-bis(hardened tallowoyloxy)-3-trimethylammonium propane chloride, dihardened tallow dimethyl ammonium chloride, di-(hydrogenated tallowoyloxyethyl)-N,N-methylhydroxyethylammonium methylsulfate, dehydrogenated palmoylethyl hydroxyethylmonium methosulfate, dipalmoxyethyl dimethylammonium chloride, and di-(oleoyloxyethyl)-N,N-methylhydroxyethylammonium methylsulfate, and mixtures thereof.

6. The liquid fabric softener composition according to claim 1, wherein the fabric softening active agent has the formula N+R1R2R3R4 X−, wherein one, two, or all three of R1, R2, and R3 independently represent hydrocarbyl groups having 12-24 carbon atoms interrupted by an amide linkage; and the remainder of R1, R2, R3 along with R4 independently represent hydrocarbyl groups having 1-4 carbon atoms or hydroxyhydrocarbyl groups having 1-4 carbon atoms; and X- is an anion.

7. The liquid fabric softener composition according to claim 6, wherein the fabric softening active agent is selected from the group consisting of methyl bis(tallow amidoethyl)-2-hydroxyethyl ammonium methyl sulfate, methyl bis(hydrogenated tallow amidoethyl)-2-hydroxyethyl ammonium methyl sulfate, and methyl bis(oleyl amidoethyl)-2-hydroxyethyl ammonium methyl sulfate, and mixtures thereof.

8. The liquid fabric softener composition according to claim 1, wherein the hydroxypropyl starch phosphate is cold water processable.

9. The liquid fabric softener composition according to claim 8, wherein the hydroxypropyl starch phosphate is derived from a waxy maize starch.

10. The liquid fabric softener composition according to claim 9, wherein the hydroxypropyl starch phosphate is jet cooked.

11. The liquid fabric softener composition according to claim 1, wherein the hydroxypropyl starch is agglomerated.

12. The liquid fabric softener composition according to claim 1, wherein the hydroxypropyl starch phosphate is derived from a waxy maize starch that has been subjected to non-ionic modification, crosslinked with phosphorus oxychloride, then physically modified by jet cooking, spray drying, and agglomeration.

13. The liquid fabric softener composition according to claim 1, wherein the liquid fabric softener is substantially free of hybrid copolymers.

14. The liquid fabric softener composition according to claim 13, wherein the liquid fabric softener is completely free of hybrid copolymers.

15. A liquid fabric softener composition comprising:
(a) a fabric softener active agent;
(b) a crosslinked hydroxypropyl starch phosphate, wherein the crosslinked hydroxypropyl starch phosphate is derived from a waxy maize starch that has been subjected to non-ionic modification with propylene oxide, crosslinked with phosphorus oxychloride, then physically modified by jet cooking, spray drying, and agglomeration; and
(c) water.

16. The liquid fabric softener composition according to claim 15, wherein the fabric softening active agent has the formula N+R1R2R3R4 X−, wherein one, two, three, or all four of R1, R2, R3 and R4 independently represent hydrocarbyl groups having 12-24 carbon atoms; and the remainder of R1, R2, R3, and R4 that do not represent said hydrocarbyl groups having 12-24 carbon atoms, if any, independently represent hydrocarbyl groups having 1-4 carbon atoms; and X− is an anion.

17. The liquid fabric softener composition according to claim 15, wherein the fabric softening active agent has the formula N+R1R2R3R4 X−, wherein one, two, or all three of R1, R2, and R3 independently represent hydrocarbyl groups having 12-24 carbon atoms interrupted by an ester linkage; and the remainder of R1, R2, R3 along with R4 independently represent hydrocarbyl groups having 1-4 carbon atoms or hydroxyhydrocarbyl groups having 1-4 carbon atoms; and X− is an anion.

18. The liquid fabric softener composition according to claim 15, wherein the fabric softening active agent has the formula N+R1R2R3R4 X−, wherein one, two, or all three of R1, R2, and R3 independently represent hydrocarbyl groups having 12-24 carbon atoms interrupted by an amide linkage; and the remainder of R1, R2, R3 along with R4 independently represent hydrocarbyl groups having 1-4 carbon atoms or hydroxyhydrocarbyl groups having 1-4 carbon atoms; and X− is an anion.

19. The liquid fabric softener composition according to claim 15, wherein the liquid fabric softener is substantially free of hybrid copolymers.

20. A liquid fabric softener composition comprising:
(a) a fabric softener active agent, which is a mono-ester, di-ester, or tri-ester quaternary ammonium compound;
(b) a crosslinked hydroxypropyl starch phosphate, wherein the crosslinked hydroxypropyl starch phosphate is derived from a waxy maize starch that has been subjected to non-ionic modification with propylene oxide, crosslinked with phosphorus oxychloride, then physically modified by jet cooking, spray drying, and agglomeration; and
(c) water.
